(19) United States
(12) Patent Application Publication
(10) Pub. No.: US 2014/0085320 A1
(43) Pub. Date: Mar. 27, 2014

(54) EFFICIENT PROCESSING OF ACCESS REQUESTS FOR A SHARED RESOURCE

(71) Applicant: APPLE INC, Cupertino, CA (US)

(72) Inventors: Peter F. Holland, Los Gatos, CA (US); Hao Chen, San Ramon, CA (US)

(73) Assignee: APPLE INC., Cupertino, CA (US)

(21) Appl. No.: 13/629,049

(22) Filed: Sep. 27, 2012

(51) Int. Cl. G06F 12/00; G09G 5/39

(52) U.S. Cl. 345/532; 711/147; 711/E12.001

(57) ABSTRACT

A system and method for efficiently processing access requests for a shared resource. A computing system includes a shared memory accessed by multiple requestors. Control logic determines two requestors seek to access a same data block within the shared memory. In response to the determination, a first requestor of the two requestors sends a read request to the shared memory on behalf of the two requestors. The second requestor of the two requestors is prevented from sending a read request. In response to detecting data is returned as a response to the read request generated by the first requestor, both the first requestor and the second requestor retrieve the data. In response to detecting a given requestor of the two requestors generates an indication that it is unable to continue retrieving the same response data, the two requestors return to generating separate, respective read requests.

### FIELD OF THE INVENTION

This invention relates to semiconductor chips, and more particularly, to efficiently processing access requests for a shared resource.

### DESCRIPTION OF THE RELEVANT ART

A semiconductor chip may include multiple functional blocks or units, each capable of accessing a shared memory. In some embodiments, the multiple functional units are individual dies on an integrated circuit (IC), such as a system-on-a-chip (SOC). In other embodiments, the multiple functional units are individual dies within a package, such as a multi-chip module (MCM). In yet other embodiments, the multiple functional units are individual dies or chips on a printed circuit board. A memory controller may control access to the shared memory.

The multiple functional units on the chip are sources for memory access requests sent to the memory controller. Additionally, one or more functional units may include multiple sources for memory access requests to send to the memory controller. For example, a display subsystem in a computing system may include multiple sources for graphics data. The design of a smartphone or computer tablet may include user interface layers, cameras, and video sources such as media players. Each of these sources may utilize frame data stored in memory. A corresponding display controller may include multiple internal pixel-processing pipelines for these sources.

Each request sent from one of the multiple sources includes both overhead processing and information retrieval processing. A large number of requests from separate sources of the multiple sources on the chip may create a bottleneck in the memory subsystem. The repeated overhead processing may reduce the subsystem performance.

In addition, two or more of the sources, such as display pipelines, may utilize information stored in a same frame buffer. One display pipeline may read a frame, process the information, and send the processed graphical information to an internal panel display. Another display pipeline may read the same frame for a near simultaneous display, process the information, and send the processed graphical information to an external network-connected display. Although the two display pipelines are accessing the same information, the number of memory read requests for a same request block of data is doubled. Both the overhead processing and the power consumption increase. Further, if the memory subsystem utilizes a cache, then the same retrieved information may be stored in the cache and cause added evictions.

In view of the above, methods and mechanisms for efficiently processing requests to a shared resource are desired.

### SUMMARY OF EMBODIMENTS

Systems and methods for efficiently processing access requests for a shared resource are contemplated. In various embodiments, a computing system includes a shared resource accessed by multiple requestors. In some embodiments, the shared resource is a shared memory and the requestors are display pipelines for both processing graphics frame data and sending the processed data to respective displays. Control logic may determine a condition wherein two requestors seek to access a same data block within the shared memory. In response to detecting the condition, the two requestors may enter a given mode of operation. In the given mode of operation, a first requestor of the two requestors may send a read request to the shared memory on behalf of the two requestors. The second requestor of the two requestors may be prevented from sending a read request.

Control logic may detect data is returned as a response to the read request generated by the first requestor. In response to the detection, both the first requestor and the second requestor retrieve the data. The first and the second requestors may store the data and later process or bypass the data. Alternatively, the first and the second requestors may immediately begin processing the data. In some embodiments, the first requestor includes a shared identifier (ID) in the generated read request. Each of the first and the second requestors may identify returned data as being a response to the read request based at least in part on the shared ID.

The latencies of handling the retrieved data within the first and the second requestors may not be equal. A given requestor of the two requestors may generate an indication that it is unable to continue retrieving the same response data. For example, logic or circuitry within the given requestor may reach a capacity condition. In some embodiments, the logic is a buffer that stores processed data and the buffer reaches a threshold capacity. In response to the indication, the two requestors may discontinue the given mode of operation and generate separate, respective read requests.

These and other embodiments will be further appreciated upon reference to the following description and drawings.

### BRIEF DESCRIPTION OF THE DRAWINGS

FIG. 1 is a generalized block diagram of one embodiment of a computing system with control of shared resource access traffic.

FIG. 2 is a generalized flow diagram of one embodiment of a method for selecting a mechanism for processing read requests for a shared resource.

FIG. 3 is a generalized flow diagram of one embodiment of a method for processing access requests for a shared resource.

FIG. 4 is a generalized flow diagram of another embodiment of a method for processing access requests for a shared resource.

FIG. 5 is a generalized block diagram of one embodiment of an apparatus capable of efficiently processing access requests for a shared resource.

FIG. 6 is a generalized block diagram of one embodiment of a display controller.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims. As used throughout this application, the word “may” is used in a permissive sense (i.e., meaning having the potential to), rather than the mandatory sense (i.e., meaning must). Similarly, the words “include,” “including,” and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. §112, paragraph six, interpretation for that unit/circuit/component.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention.

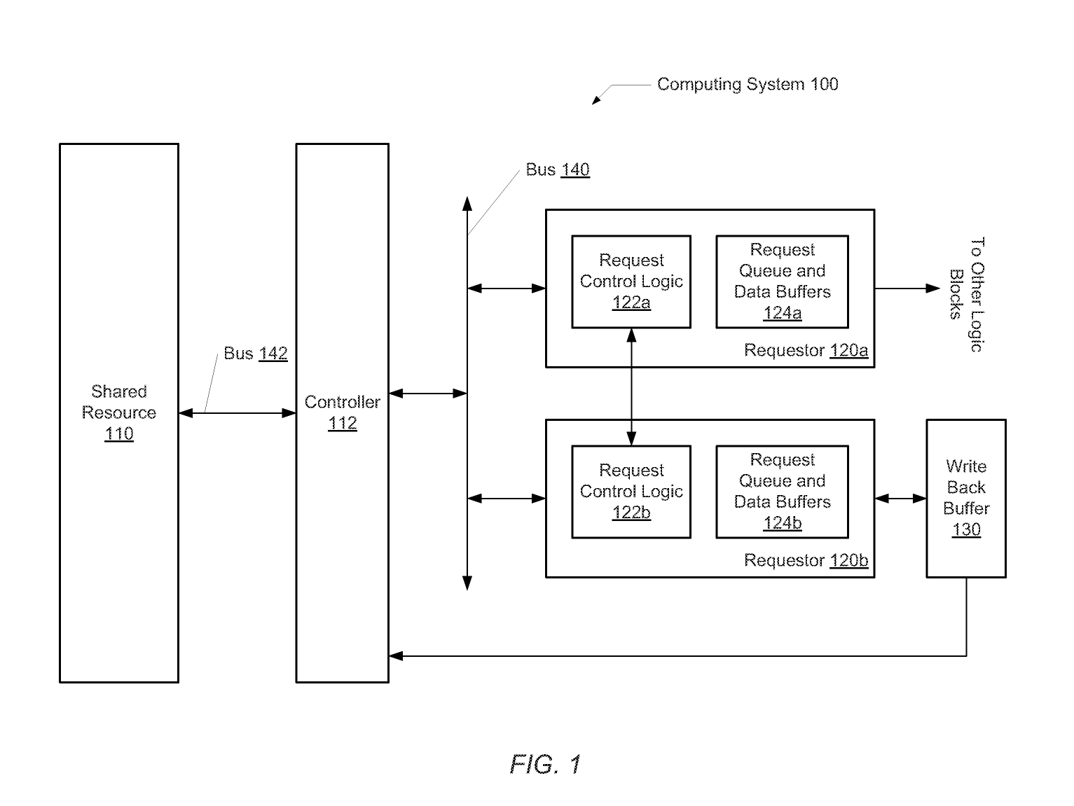

Referring to FIG. 1, a generalized block diagram of one embodiment of a computing system 100 with control of shared resource access traffic is shown. As shown, multiple requestors 120a-120b access a shared resource 110 through a controller 112. Although two requestors 120a-120b are shown, any number of multiple requestors may be used. In some embodiments, the shared resource 110 is a shared memory and the controller 112 is a memory controller. Additionally, a shared memory may include one or more levels of a cache hierarchy to reduce memory latency. In other examples, the shared resource 110 may be a complex arithmetic unit or a network switching fabric. Other examples of a resource and any associated controller are possible and contemplated. The controller 112 may receive requests that access the shared resource 110 from multiple sources, such as requestors 120a-120b.

The computing system 100 may include a hybrid arbitration scheme wherein the controller 112 includes a centralized arbiter and one or more of the requestors 120a-120b include distributed arbitration logic. For example, one or more of the requestors 120a-120b may include an arbiter for selecting a given request to place on the bus 140 from multiple requests generated by multiple internal sources. The arbiter within the controller 112 may select a given request to place on the bus 142 from multiple requests received from the requestors 120a-120b. The arbitration logic may include any type of request traffic control scheme. For example, a round robin, a least-recently-used, an encoded priority, and other schemes may be used.

Each of the requestors 120a-120b may include interface logic (not shown) to connect to the bus 140. A given protocol may be used by the interface logic dependent on the bus 140. In some examples, the bus 140 may be a switch fabric. Arbitration logic may be used to send generated requests from the requestors 120a-120b to the bus 140 and later received by the controller 112. Responses for the requests may be later sent by the controller 112 and retrieved from the bus 140 by one or more of the requestors 120a-120b. In some embodiments, polling logic within the interfaces may be used to retrieve associated response data from the bus 140.

In various embodiments, each of the requestors 120a-120b in the system 100 may store generated requests for the shared resource 110. A request queue may be used for the storage. Additionally, the requestors 120a-120b may include response data buffers for storing corresponding response data. The requestors 120a-120b may use request queues and response data buffers 124a-124b, respectively, for the storage. Although not shown, in some embodiments, each of the requestors 120a-120b may include processing logic to process the response data received from the bus 140.

The processed data may be sent to other components within the computing system 100. For example, the requestor 120a may send processed data to other logic blocks within the system 100. The requestor 120a may use a protocol for sending the processed data dependent upon the type of the logic blocks. The requestor 120b may send processed data to a write back buffer 130. The write back buffer 130 may later sends the processed data to the shared resource 110 via the controller 112. In some embodiments, the write back buffer 130 utilizes the bus 140 for sending processed data to the shared resource 110. In other embodiments, the write back buffer 130 utilizes another connection or bus separate from the bus 140 to send the processed data to the shared resource 110.

The requests generated by each of the requestors 120a-120b may seek to access a block of data. The block of data, or data block, may be a set of bytes stored in contiguous memory locations. The number of bytes in a data block may be varied according to design choice, and may be of any size. As an example, 64 byte blocks may be used. The data block may be the size of data to access with a generated request. In implementations with the shared resource 110 used as a shared memory, wherein the shared memory includes one or more levels of a cache hierarchy, the data block size may be the same size as a cache block. The cache block may also be referred to as a cache line. The cache line size may be the number of bytes of data used as a unit for cache coherency purposes.

In various embodiments, each of the requestors 120a-120b seeks to access data that corresponds to a same data block. The requestors 120a-120b may be accessing multiple same data blocks. For example, a particular region of data may be read by each of the requestors 120a-120b in a relatively similar period of time. In one example, the requestors 120a-120b are display pipelines accessing a same graphics frame of data. Other examples are possible and contemplated. Again, in some implementations, the shared resource 110 is used as a shared memory, wherein the shared memory includes one or more levels of a cache hierarchy. While accessing same data blocks within the same particular region of memory, one of the requestors 120a-120b may have a greater latency for processing or bypassing received data blocks.

Continuing with the above example, the faster one of the requestors 120a-120b may get far ahead of the other one of the requestors 120a-120b and cause the data blocks from earlier in the region, which the slower requestor still has yet to read, to be replaced in the memory cache. Therefore, read requests from the slower one of the requestors 120a-120b access the shared memory, rather than the memory cache. Both latency and power consumption may increase due to these types of accesses. Additionally, for a given data block within the particular region, two read requests are sent to the controller 112, which increase access traffic within the system 100.

In response to determining each of the requestors 120a-120b seeks to access data that corresponds to a same data block, a first requestor of the requestors 120a-120b may send a read request on behalf of both requestors 120a-120b to the controller 112. The second one of the requestors 120a-120b may be prevented from sending read requests to the controller 112. Therefore, the number of read requests sent to the controller 112 is reduced. Additionally, the number of read requests accessing a shared memory, rather than a memory cache, may be reduced. In some embodiments, the second requestor adjusts a number of request credits according to a number of requests sent by the first requestor on behalf of the two requestors.

In response to detecting data returned as a response to the read request generated by the first requestor, each of the requestors 120a-120b may read the data from the bus 140. Each of the requestors 120a-120b may store the data in response data buffers. Reading the data from the bus 140 and storing or beginning processing with the data may be referred to as retrieving the data. In some embodiments, the first one of the requestors 120a-120b may include an identifier (ID) in the generated read requests. Each of the requestors 120a-120b may identify the data returned as being a response to the read request based at least in part on the ID. Each of the requestors 120a-120b may poll or snoop the bus 140 in order to retrieve response data.

The request control logic 122a-122b for the requestors 120a-120b may communicate in order to determine when each of the requestors generate respective read requests, generate read requests on behalf of both requestors, and prevent read requests from being generated or prevent generated read requests from being sent to the bus 140. Given qualifying conditions may be detected by one or more of the request control logic 122a-122b to determine what actions to take.

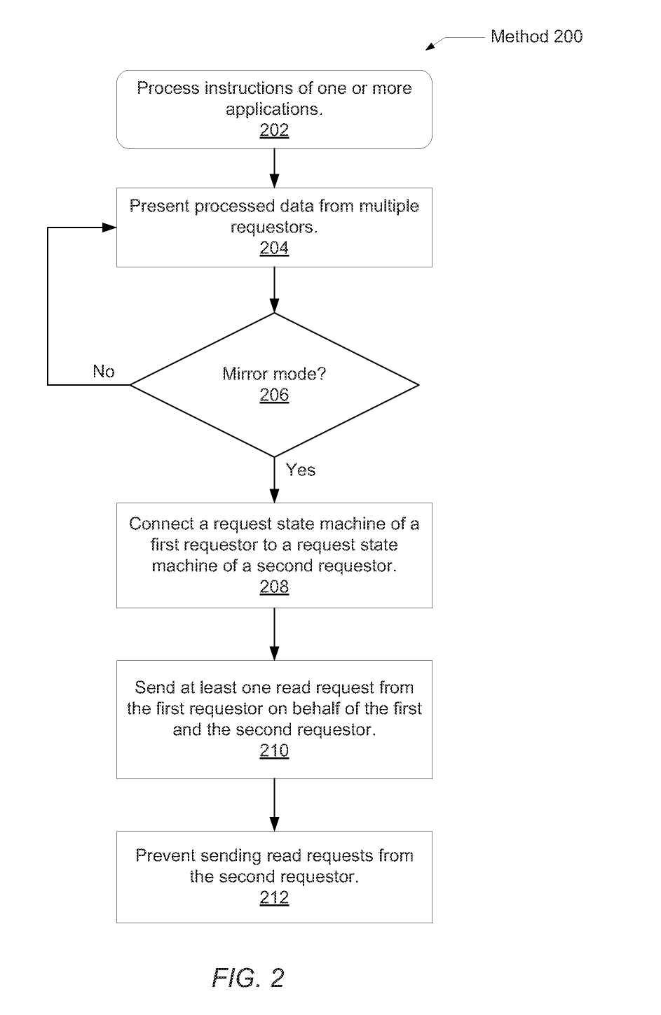

Referring now to FIG. 2, a generalized flow diagram of one embodiment of a method 200 for selecting a mechanism for processing read requests for a shared resource is shown. For purposes of discussion, the steps in this embodiment are shown in sequential order. However, in other embodiments some steps may occur in a different order than shown, some steps may be performed concurrently, some steps may be combined with other steps, and some steps may be absent.

In block 202, instructions of one or more software applications are processed by a computing system. In this example, a “mirror” mode is established in which two displays are to present the same data. In various embodiments, establishing such a mode may be accomplished by writing predetermined values to configuration registers. In other embodiments, the mode may be otherwise established. In some embodiments, the computing system is an embedded system, such as a system-on-a-chip. The system may include multiple functional units that act as requestors for a shared resource. In various embodiments, the shared resource is a shared memory. The requestors may generate read requests to send to the shared resource. Associated response data may be returned to the requestors. In some embodiments, the requestors process the data. The requestors may store the data prior to processing the data. In block 204, multiple requestors may present processed data to other functional units or storage queues.

A certain qualifying condition may arise wherein at least two requestors seek to access the same data block. Rather than continue a current mode of operation, control logic may change the mode of operation to a mirror mode, as discussed above, for the two requestors. If such a mirror mode is detected (conditional block 206), then in block 208, a request state machine of a first requestor may be connected to (or otherwise communicate with) a request state machine of a second requestor. For example, the first and second state machines may operate in a master-slave relationship whereby the second state machine is responsive to actions taken by the first state machine. In other embodiments, other logic may be utilized to control the states of the second state machine responsive to the first state machine. Various ways for coupling the state machines are possible and are contemplated. In block 210, at least one read request may be generated by the first requestor and sent to the shared resource on behalf of the first and the second requestor. During mirror mode, only one of the state machines generates and conveys requests for data that is to be utilized by both the first and second requestors. In various embodiments, the request generated by the first requestor may include an indication that it represents a mirror mode request (e.g., a particular identifying bit). On return of requested data, the second requestor may detect the data as mirror mode data (e.g., via the identifier) and obtain the data for utilization. Similarly, the first requestor obtains and utilizes the requested data. In this manner, a single request is used to obtain data for both requestors. In block 212, the second requestor does not send a request for the same data to the shared resource while in mirror mode.

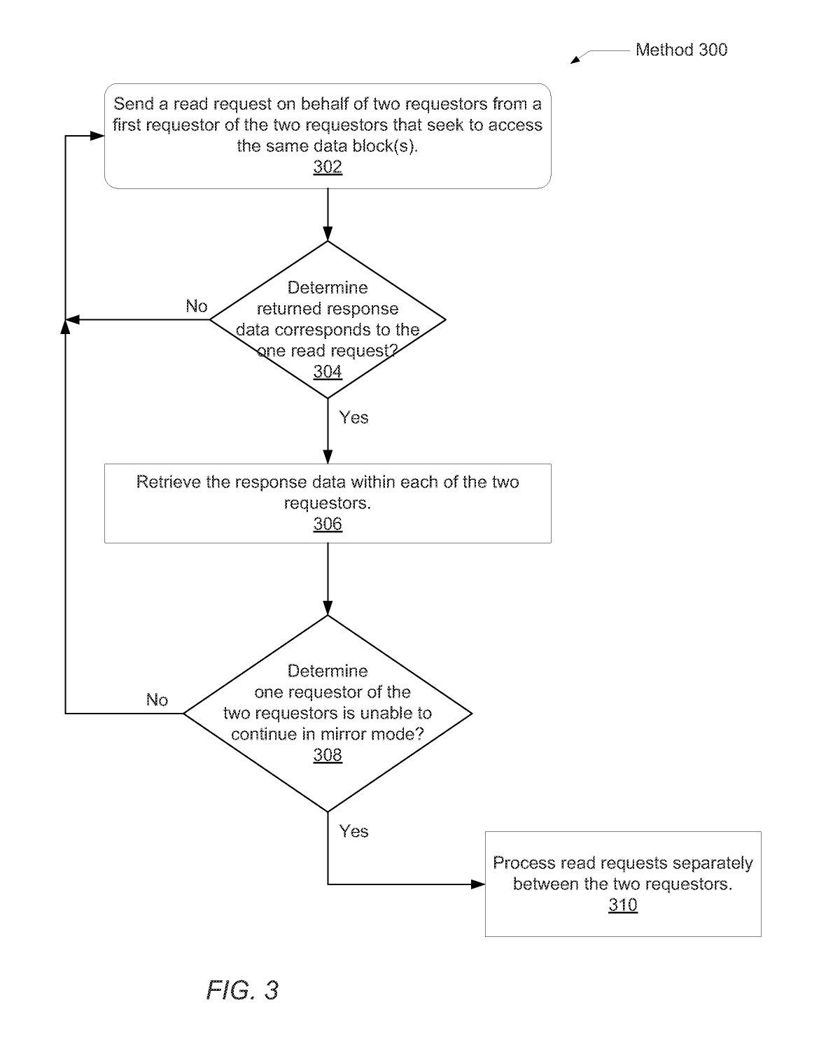

Referring now to FIG. 3, a generalized flow diagram of one embodiment of a method 300 for processing access requests for a shared resource is shown. For purposes of discussion, the steps in this embodiment are shown in sequential order. However, in other embodiments some steps may occur in a different order than shown, some steps may be performed concurrently, some steps may be combined with other steps, and some steps may be absent.

In block 302, a first requestor of two requestors sends a read request on behalf of the two requestors. The read request may be sent to a controller that controls access to a shared resource, such as a shared memory. The two requestors may seek to access the same data block(s). The two requestors may have entered a mode of operation based on configuration data or otherwise. In some embodiments, the two requestors are display pipelines accessing the same graphical data within the same frame.

If returned response data corresponds to the read request (conditional block 304), then in block 306, each of the two requestors may retrieve the response data. In some embodiments, the read request generated by the first requestor includes a shared identifier (ID) recognized by each of the first requestor and the second requestor. Each of the two requestors may identify the data returned as being a response to the read request based at least in part on the shared ID. In some embodiments, the data returned as a response to the read request is returned via a bus. The bus may be snooped by each of the two requestors.

Due to different latencies, a given requestor of the two requestors may be unable to continue continue in mirror mode. For example, logic or circuitry within the given requestor may reach a capacity threshold. For example, a buffer may reach a capacity threshold that is at or near a full capacity condition. Upon reaching the capacity threshold, an indication may be generated indicating the current mode of operation should cease. If one of the two requestors is determined to be unable to continue in mirror mode (conditional block 308), then in block 310, the read requests for the shared resource may return to being generated and processed separately between the two requestors.

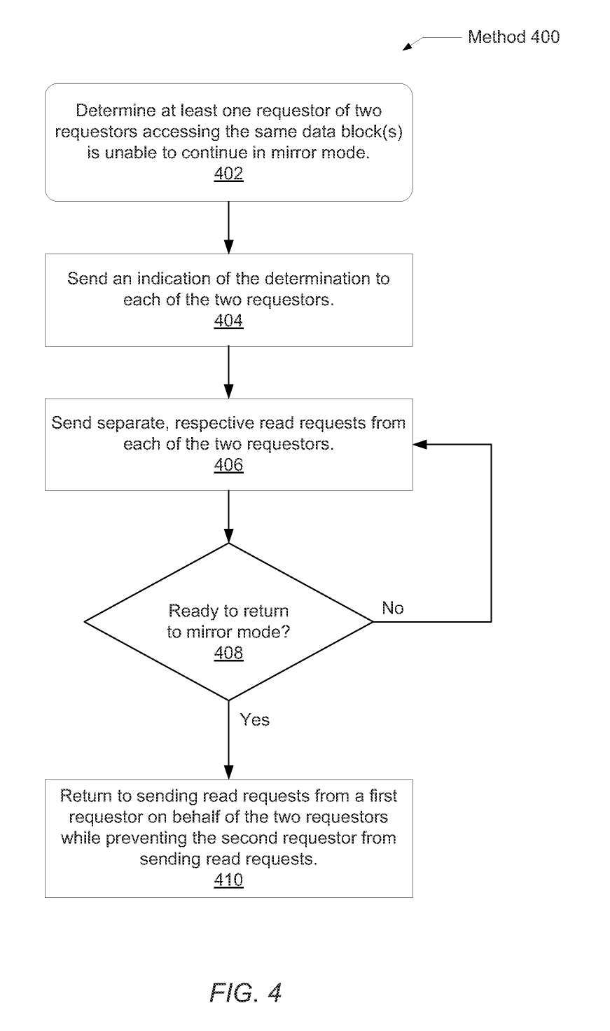

Referring now to FIG. 4, a generalized flow diagram of another embodiment of a method 400 for processing access requests for a shared resource is shown. For purposes of discussion, the steps in this embodiment are shown in sequential order. However, in other embodiments some steps may occur in a different order than shown, some steps may be performed concurrently, some steps may be combined with other steps, and some steps may be absent.

In block 402, it is determined at least one requestor of two requestors accessing the same data block(s) is unable to continue in mirror mode. In block 404, an indication of the determination may be sent to each of the two requestors. The current mirror mode of operation, which may be also referred to as the first mode, may be ceased. A different mode of operation, which may also be referred to as the second mode, may begin. In block 406, separate, respective read requests may be sent from each of the two requestors in the second mode. In various embodiments, requests may be temporarily suspended before entering non-mirror mode in which both requestors generate requests. In some embodiments, each of the two requestors includes a separate, different identifier (ID) in respective read requests.

In some examples, after some time of operating in the second mode of operation, the two requestors may return to the first mode. In some embodiments, in response to determining the first requestor and the second requestor have reached an end of data corresponding to the same block (e.g., a given frame), and additionally, each of the first requestor and the second requestor both seek access to further data in a same block, the first requestor and the second requestor may transition to operate in the mirror mode. In other embodiments, the two requestors may not reach an end of data corresponding to the same block, but still seek to access the data in a same block. The two requestors may return to operating in the first mode in response to detecting this condition.

If it is determined that mirror mode is re-entered (conditional block 408), then in block 410, read requests may be sent from the first requestor on behalf of the two requestors while preventing the second requestor from sending read requests. In various embodiments, the two requestors may be display pipelines used in an embedded system. Further details are provided below.

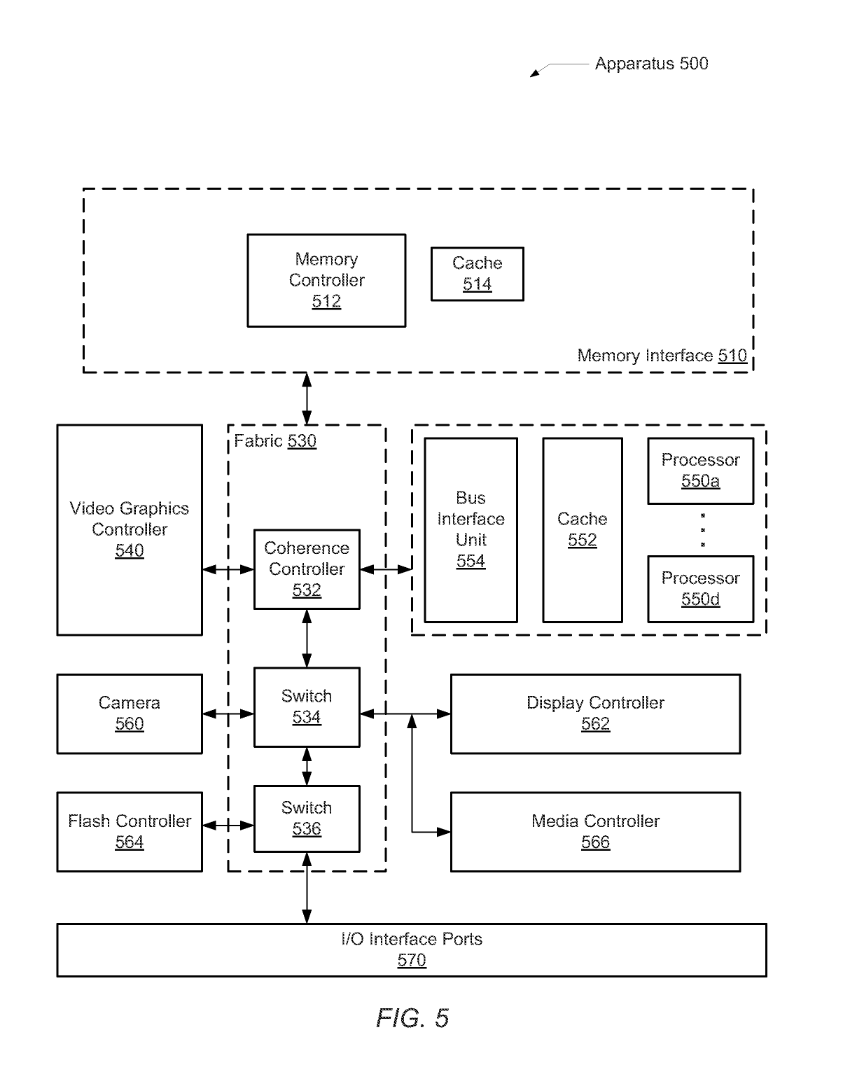

Referring to FIG. 5, a generalized block diagram illustrating one embodiment of an apparatus 500 capable of efficiently processing access requests for a shared resource is shown. The apparatus 500 includes multiple functional blocks or units. In some embodiments, the multiple functional units are individual dies on an integrated circuit (IC), such as a system-on-a-chip (SOC). In other embodiments, the multiple functional units are individual dies within a package, such as a multi-chip module (MCM). In yet other embodiments, the multiple functional units are individual dies or chips on a printed circuit board. The multiple functional blocks or units may each be capable of accessing a shared memory.

In various embodiments, the apparatus 500 is a SOC that includes multiple types of IC designs on a single semiconductor die, wherein each IC design provides a separate functionality. The IC designs on the apparatus 500 may also be referred to as functional blocks, functional units, or processing units on the apparatus 500. Traditionally, each one of the types of IC designs, or functional units, may have been manufactured on a separate silicon wafer. In the illustrated embodiment, the apparatus 500 includes multiple IC designs; a fabric 530 for high-level interconnects and chip communication, a memory interface 510, and various input/output (I/O) interfaces 570. Clock sources, such as phase lock loops (PLLs), and a centralized control block for at least power management are not shown for ease of illustration.

The multiple IC designs within the apparatus 500 may include various analog, digital, mixed-signal and radio-frequency (RF) blocks. For example, the apparatus 500 may include one or more processors 550a-550d with a supporting cache hierarchy that includes at least cache 552. In some embodiments, the cache 552 may be a shared level two (L2) cache for the processors 550a-550d. In addition, the multiple IC designs may include a display controller 560, a flash memory controller 564, and a media controller 566. Further, the multiple IC designs may include a video graphics controller 540 and one or more processing blocks associated with real-time memory performance for display and camera subsystems, such as camera 560.

Any real-time memory peripheral processing blocks may include image blender capability and other camera image processing capabilities as is well known in the art. The apparatus 500 may group processing blocks associated with non-real-time memory performance, such as the media controller 566, for image scaling, rotating, and color space conversion, accelerated video decoding for encoded movies, audio processing and so forth. The units 560 and 566 may include analog and digital encoders, decoders, and other signal processing blocks. In other embodiments, the apparatus 500 may include other types of processing blocks in addition to or in place of the blocks shown.

In various embodiments, the fabric 530 provides a top-level interconnect for the apparatus 500. For example, connections to the cache coherence controller 532 may exist for various requestors within the apparatus 500. A requestor may be one of the multiple IC designs on the apparatus 500. The cache coherence controller 532 may provide to the multiple IC designs a consistent data value for a given data block in the shared memory, such as off-chip dynamic random access memory (DRAM). The coherence controller 532 may use a cache coherency protocol for memory accesses to and from the memory interface 510 and one or more caches in the multiple IC designs on the apparatus 500. The switch 534 may be used to aggregate traffic from these remaining multiple IC designs.

The memory interface 510 may include one or more memory controllers 512 and one or more memory caches 514 for the off-chip memory, such as synchronous DRAM (SDRAM). The memory caches may be used to reduce the demands on memory bandwidth and average power consumption.

The cach 514 may store one or more blocks, each of which is a copy of data stored at a corresponding address in the system memory. As used herein, a “block” is a set of bytes stored in contiguous memory locations, which are treated as a unit for coherency purposes although the caches 514a-514b may not participate in the cache coherency protocol. As used herein, the terms “cache block”, “block”, “cache line”, and “line” are interchangeable. The number of bytes in a block may be varied according to design choice, and may be of any size. As an example, 64 byte blocks may be used.

The memory controller(s) 512 may also include logic for supporting a given protocol used to interface to memory channels. The protocol may determine values used for information transfer, such as a number of data transfers per clock cycle, signal voltage levels, signal timings, signal and clock phases and clock frequencies. Protocol examples include DDR2 (Double Data Rate, version 2) SDRAM, DDR3 SDRAM, GDDR4 (Graphics Double Data Rate, version 4) SDRAM, and GDDR5 (Graphics Double Data Rate, version 5) SDRAM.

The interface between the combination of the memory interface 510 and the coherency controller 532 and the remainder of the apparatus 500, which includes the multiple IC designs and the switches 534 and 536, includes multiple buses. Asynchronous memory requests, responses, snoops, snoop responses, and input/output (I/O) transactions are visible at this interface with temporal relationships.

The display controller 562 sends graphics output information that was rendered to one or more display devices. The rendering of the information may be performed by the display controller 562, by the video graphics controller 540, or by both controllers 562 and 540. Alternatively, the display controller 562 may send graphics output information to the video graphics controller 540 to be output to one or more display devices. The graphics output information may correspond to frame buffers accessed via a memory mapping to the memory space of a GPU within the video graphics controller 540. The memory mappings may be stored and updated in address translators. The frame data may be for an image to be presented on a display. The frame data may include at least color values for each pixel on the screen.

The display controller 562 may include one or more display pipelines. Each display pipeline may send rendered graphical information to a separate display. For example, a display panel internal to a computing device that includes the apparatus 500 may be used. Additionally, a network-connected display may also be supported. Each display pipeline within the display controller 562 associated with a separate display screen may include one or more internal pixel-processing pipelines. A further description of the internal pixel-processing pipelines is provided later.

Each of the internal pixel-processing pipelines within the one or more display pipelines may independently and simultaneously access respective frame buffers stored in memory. Although the cache 514 may reduce the average latency of memory access requests, an entire frame buffer may not fit within any cache 514. Therefore, the off-die memory is additionally accessed.

In one example, a user wishes to present a same image on both an internal panel display of a smartphone or a computer tablet and a network-connected display. The user may be using the image for a presentation. Two display pipelines within the display controller 562 may be used for the internal panel display and the network-connected display. The two display pipelines may be accessing a same graphics frame. The two display pipelines may each send a read request to the memory interface 510, thus increasing the traffic within the fabric 530 and the memory interface 510.

Additionally, while accessing same data blocks within the same frame, one of the two display pipelines may have a greater latency for processing retrieved data blocks. The faster one of the two display pipelines may get far ahead of the other one of the display pipelines and cause the data blocks from earlier in the frame, which the slower display pipeline still has yet to read, to be replaced in a cache. Therefore, read requests from the slower one of the display pipelines access the off-die SDRAM, than an on-die memory cache. Both latency and power consumption may increase due to these types of accesses. In response to detecting the two display pipelines seek to access data within the same frame, the two display pipelines may operate in the previously described first mode of operation. Before providing details of the display pipelines operating in the first mode, a further description of the other components of the apparatus 500 is provided.

Each one of the processors 550a-550d may include one or more cores and one or more levels of a cache memory subsystem. Each core may support the out-of-order execution of one or more threads of a software process and include a multi-stage pipeline. Each one of the processors 550a-550d may include circuitry for executing instructions according to a predefined general-purpose instruction set. For example, the ARM®, x86®, x86-64®, Alpha®, MIPS®, PA-RISC®, SPARC® or any other instruction set architecture may be selected.

Generally, the processors 550a-550d may include multiple on-die levels (L1, L2, L3 and so forth) of caches for accessing data and instructions. If a requested block is not found in the on-die caches or in the off-die cache 552, then a read request for the missing block may be generated and transmitted to the memory interface 510 or to on-die flash memory (not shown) controlled by the flash controller 564. The flash memory may be a non-volatile memory block formed from an array of flash memory cells. Alternatively, the memory 550 may include other non-volatile memory technology. The bus interface unit (BIU) 554 may provide memory access requests and responses for at least the processors 550a-550d.

Other processor cores on apparatus 500 may not include a mirrored silicon image of processors 550a-550d. These other processing blocks may have a micro-architecture different from the micro-architecture used by the processors 550a-550d. For example, other processors may have a micro-architecture that provides high instruction throughput for a computational intensive task, such as a single instruction multiple data (SIMD) core. Examples of SIMD cores include graphics processing units (GPUs), digital signal processing (DSP) cores, or other. For example, the video graphics controller 540 may include one or more GPUs for rendering graphics for games, user interface (UI) effects, and other applications.

The apparatus 500 may include processing blocks for real-time memory performance, such as the camera 560 and the display controller 562, as described earlier. In addition, the apparatus 500 may including processing blocks for non-real-time memory performance for image scaling, rotating, and color space conversion, accelerated video decoding for encoded movies, audio processing and so forth. The media controller 566 is one example. The I/O interface ports 570 may include interfaces well known in the art for one or more of a general-purpose I/O (GPIO), a universal serial bus (USB), a universal asynchronous receiver/transmitter (uART), a FireWire interface, an Ethernet interface, an analog-to-digital converter (ADC), a DAC, and so forth.

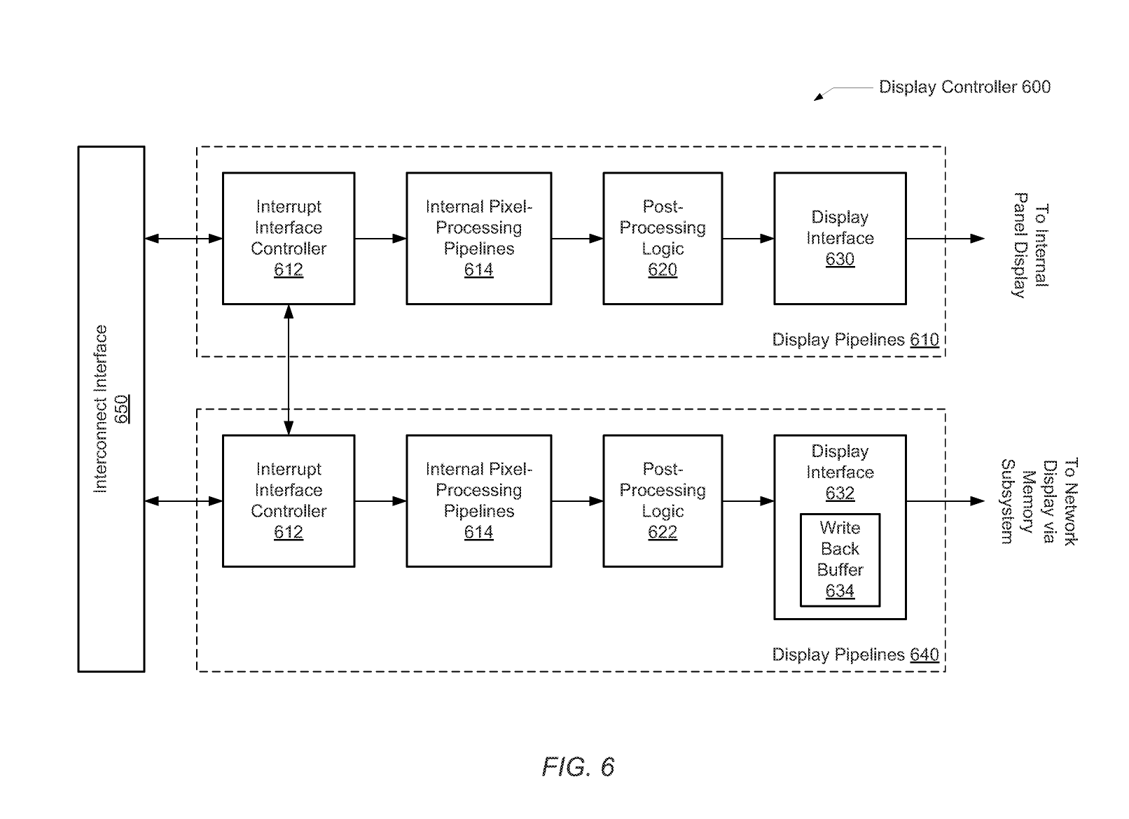

Turning now to FIG. 6, a generalized block diagram of one embodiment of a display controller 600 is shown. The display controller 600 includes an interconnect interface 650 and two display pipelines 610 and 640. Although two display pipelines are shown, the display controller 600 may include another number of display pipelines. Each of the display pipelines may be associated with a separate display screen. For example, the display pipeline 610 may send rendered graphical information to an internal display panel. The display pipeline 640 may send rendered graphical information to a network-connected display. Other examples of display screens may also be possible and contemplated.

The interconnect interface 650 may include multiplexers and control logic for routing signals and packets between the display pipelines 610 and 640 and a top-level fabric. Each of the display pipelines may include an interrupt interface controller 612. The interrupt interface controller 612 may include logic to expand a number of sources or external devices to generate interrupts to be presented to the internal pixel-processing pipelines 614. The controller 612 may provide encoding schemes, registers for storing interrupt vector addresses, and control logic for checking, enabling, and acknowledging interrupts. The number of interrupts and a selected protocol may be configurable. In some embodiments, the controller 612 uses the AMBA® AXI (Advanced eXtensible Interface) specification. Each of the controllers 612 within the display pipelines 610 and 640 may communicate with one another. For example, when operating in the previously described first mode, the controllers may exchange an ID included in read requests, detect when to enter and to exit the first mode, and exchange information regarding request credits.

Each display pipeline within the display controller 562 may include one or more internal pixel-processing pipelines 614. The internal pixel-processing pipelines 614 may include one or more ARGB (Alpha, Red, Green, Blue) pipelines for processing and displaying user interface (UI) layers. The internal pixel-processing pipelines 614 may include one or more pipelines for processing and displaying video content such as YUV content. In some embodiments, each of the internal pixel-processing pipelines 614 include blending circuitry for blending graphical information before sending the information as output to respective displays.

A layer may refer to a presentation layer. A presentation layer may consist of multiple software components used to define one or more images to present to a user. The UI layer may include components for at least managing visual layouts and styles and organizing browses, searches, and displayed data. The presentation layer may interact with process components for orchestrating user interactions and also with the business or application layer and the data access layer to form an overall solution. However, the internal pixel-processing pipelines 614 handle the UI layer portion of the solution.

The YUV content is a type of video signal that consists of three separate signals. One signal is for luminance or brightness. Two other signals are for chrominance or colors. The YUV content may replace the traditional composite video signal. The MPEG-2 encoding system in the DVD format uses YUV content. The internal pixel-processing pipelines 614 handle the rendering of the YUV content.

The display pipeline 610 may include post-processing logic 620. The post-processing logic 620 may be used for color management, ambient-adaptive pixel (AAP) modification, dynamic backlight control (DPB), panel gamma correction, and dither. The display interface 630 may handle the protocol for communicating with the internal panel display. For example, the Mobile Industry Processor Interface (MIPI) Display Serial Interface (DSI) specification may be used. Alternatively, a 4-lane Embedded Display Port (eDP) specification may be used.

The display pipeline 640 may include post-processing logic 622. The post-processing logic 622 may be used for supporting scaling using a 5-tap vertical, 9-tap horizontal, 16-phase filter. The post-processing logic 622 may also support chroma subsampling, dithering, and write back into memory using the ARGB888 (Alpha, Red, Green, Blue) format or the YUV420 format. The display interface 632 may handle the protocol for communicating with the network-connected display. A direct memory access (DMA) interface may be used that includes a write back buffer 634.

The latency for the display pipeline 640 may be greater than the latency for the display pipeline 610. When operating in the previously described first mode, the display pipeline 610 may send read requests to the memory controller on behalf of the two pipelines 610 and 640. Processed data stored in the write back buffer 634 may be returned to the memory interface for storage. At a later time, the processed data stored in memory may be further processed and/or encoded for transmission to the network-connected display. The write back buffer may reach a capacity threshold during processing of a given frame. The threshold may be a programmable value stored in a configuration register. When the threshold is reached, an indication may be sent to control logic within the controller 612 to cease operation in the previously described first mode. Upon starting a next frame, the first mode may be used again.

In various embodiments, program instructions of a software application may be used to implement the methods and/or mechanisms previously described. The program instructions may describe the behavior of hardware in a high-level programming language, such as C. Alternatively, a hardware design language (HDL) may be used, such as Verilog. The program instructions may be stored on a computer readable storage medium. Numerous types of storage media are available. The storage medium may be accessible by a computer during use to provide the program instructions and accompanying data to the computer for program execution. In some embodiments, a synthesis tool reads the program instructions in order to produce a netlist comprising a list of gates from a synthesis library.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. An apparatus comprising:
a memory controller configured to control access to a shared memory;
a first requestor configured to generate read requests for data in the memory; and
a second requestor configured to generate read requests for data in the memory; and
wherein in response to detecting a first mode of operation in which both the first requestor and the second requestor seek to access data that corresponds to a same block:
the first requestor is configured to send a read request for the data; and
the second requestor is prevented from sending a read request.

2. The apparatus as recited in claim 1, wherein in response to detecting data returned as a response to the read request generated by the first requestor, both the first requestor and the second requestor are configured to retrieve the data.

3. The apparatus as recited in claim 2, wherein the read request generated by the first requestor includes an identifier (ID), and the first requestor and the second requestor identify the data returned as being a response to the read request based at least in part on the ID.

4. The apparatus as recited in claim 3, wherein the data returned as a response to the read request is returned via a bus, which is snooped by both the first requestor and the second requestor.

5. The apparatus as recited in claim 1, wherein the first requestor is configured to generate a plurality of read requests for additional data that corresponds to the same block, and the second requestor is prevented from sending read requests for the additional data while a given condition is detected.

6. The apparatus as recited in claim 5, wherein said condition includes a determination that both the first requestor and the second requestor seek to access data corresponding to a same block, and a neither the first requestor nor the second requestor have received an indication that the first mode should cease.

7. The apparatus as recited in claim 6, wherein said indication that operation in the first mode should cease includes an indication that circuitry corresponding to either or both of the first requestor and the second requestor has reached or is nearing a capacity condition.

8. The apparatus as recited in claim 7, wherein in response to ceasing operation in the first mode, the first requestor and the second requestor operate in a second mode whereby the second requestor generates read requests for the data corresponding to the same block.

9. The apparatus as recited in claim 8, wherein in response to determining the first requestor and the second requestor have reached an end of data corresponding to the same block, and each of the first requestor and the second requestor both seek access to further data in a same block, the first requestor and the second requestor are configured to operate in the first mode.

10. The apparatus as recited in claim 9, wherein the second requestor is further configured to adjust a number of request credits according to a number of requests sent by the first requestor.

11. The apparatus as recited in claim 9, wherein the first requestor is corresponds to a first display device, the second requestor corresponds to a second display device, and the block of data corresponds to frame data.

12. The apparatus as recited in claim 11, wherein the apparatus is a system-on-a-chip (SOC).

13. A method comprising:
controlling access to a shared memory via a memory controller;
generating read requests for data in the shared memory for a first requestor;
generating read requests for data in the shared memory for a second requestor; and
wherein in response to detecting a first mode of operation in which both the first requestor and the second requestor seek to access data that corresponds to a same block:
the first requestor is configured to send a read request for the data; and
the second requestor is prevented from sending a read request.

14. The method as recited in claim 13, wherein in response to detecting data returned as a response to the read request generated by the first requestor, the method further comprises retrieving the data within both the first requestor and the second requestor.

15. The method as recited in claim 14, further comprising identifying the data returned as being a response to the read request generated by the first requestor based at least in part on an identifier (ID) included in the read request.

16. The method as recited in claim 13, further comprising generating a plurality of read requests within the first requestor for additional data that corresponds to the same block, and preventing the second requestor from sending read requests for the additional data while a given condition is detected.

17. The method as recited in claim 16, wherein said condition includes a determination that both the first requestor and the second requestor seek to access data corresponding to a same block, and a neither the first requestor nor the second requestor have received an indication that the first mode should cease.

18. A display controller comprising:
an interface configured to receive frame data for an image to be presented on a plurality of displays;
a first display pipeline configured to generate read requests for frame data in a shared memory;
a second display pipeline configured to generate read requests for frame data in the shared memory; and
control logic, wherein in response to detecting both the first display pipeline and the second display pipeline seek to access data that corresponds to a same block, the control logic is configured to operate the first display pipeline and the second display pipeline in a first mode whereby:
the first display pipeline is configured to send a read request for the data; and
the second display pipeline is prevented from sending a read request.

19. The display controller as recited in claim 18, wherein in response to detecting data returned as a response to the read request generated by the first display pipeline, both the first display pipeline and the second display pipeline are configured to retrieve the data.

20. The display controller as recited in claim 19, wherein the read request generated by the first display pipeline includes an identifier (ID), and the first display pipeline and the second display pipeline identify the data returned as being a response to the read request based at least in part on the ID.

21. The display controller as recited in claim 20, wherein the data returned as a response to the read request is returned via a bus, which is snooped by both the first display pipeline and the second display pipeline.

22. A non-transitory computer readable storage medium comprising program instructions operable to efficiently process access requests for a shared memory in a computing system, wherein the program instructions are executable to:
control access to the shared memory via a memory controller;
generate read requests for data in the shared memory for a first requestor;
generate read requests for data in the shared memory for a second requestor; and
wherein in response to detecting both the first requestor and the second requestor seek to access data that corresponds to a same block, operate the first requestor and the second requestor in a first mode whereby:
the first requestor is configured to send a read request for the data; and
the second requestor is prevented from sending a read request.

23. The storage medium as recited in claim 22, wherein in response to detecting data returned as a response to the read request generated by the first requestor, the program instructions are further configured to retrieve the data within both the first requestor and the second requestor.

24. The storage medium as recited in claim 23, wherein the program instructions are further executable to identify the data returned as being a response to the read request generated by the first requestor based at least in part on an identifier (ID) included in the read request.

25. The storage medium as recited in claim 22, wherein the program instructions are further executable to generate a plurality of read requests within the first requestor for additional data that corresponds to the same block, and prevent the second requestor from sending read requests for the additional data while a given condition is detected.
